(19) United States
(12) Patent Application Publication
(10) Pub. No.: US 2008/0294893 A1
(43) Pub. Date: Nov. 27, 2008

(54) DEVICE AND METHOD FOR SECURITY RECONFIGURATION

(75) Inventors: Jui-Hung Kao, Hsinchu (TW); Tuan-Che Chen, Hsinchu (TW); Zong-Hua Liu, Hsinchu (TW); Kai-Hsiu Chen, Hsinchu (TW); Jyh-Cheng Chen, Hsinchu (TW)

Correspondence Address: DLA PIPER US LLP, 2000 UNIVERSITY AVENUE, E. PALO ALTO, CA, 94303-2248, US

(73) Assignee: National Tsing Hua University, Hsinchu (TW)

(21) Appl. No.: 12/107,702

(22) Filed: Apr. 22, 2008

(30) Foreign Application Priority Data
May 24, 2007 (TW) 096118522

(51) Int. Cl. H04L 9/00

(52) U.S. Cl. 713/164

(57) ABSTRACT

A security reconfigurable device is adapted for use in an integrated wireless network integrating at least two wireless networks, and includes a plurality of security modules and a control unit. The security modules are used to respectively realize security mechanisms related to the wireless networks. According to security requirements, the control unit selects one of the security modules for operation. The security reconfigurable device can reduce time and cost for updating the security mechanisms. A method for security reconfiguration is also disclosed.

### CROSS-REFERENCE TO RELATED APPLICATION

This application claims priority of Taiwanese Application No. 096118522, filed on May 24, 2007.

### BACKGROUND OF THE INVENTION

1. Field of the Invention

The invention relates to a security device, more particularly to a security reconfigurable device and a method for security reconfiguration.

2. Description of the Related Art

Wireless networks are very popular nowadays, and there are many different wireless networks available. Examples of current wireless networks include wireless local-area network (WLAN), third generation (3G) mobile communications network, satellite network, personal area network (PAN), sensor network, etc. These different wireless networks not only co-exist, the wireless communications technologies employed thereby have evolved independently and thus have their own merits and drawbacks. Take the wireless local-area network as an example. Since the wireless local-area network uses the IEEE 802.11x wireless communications standard, the transmission speed is relatively fast, and the network is suitable for transmitting multimedia data. However, the signal coverage is limited, and the network is unsuited for use by users moving at a high speed. The 3G mobile communications network adopts the IMT-2000 wireless communications standard. Contrary to the wireless local-area network, the bandwidth of the 3G mobile communications network is limited, and the network is not suitable for transmitting complicated multimedia data requiring a large amount of bandwidth. However, it has a very large signal coverage, and is able to support use by users moving at a high speed.

Since these different wireless networks have their own merits and drawbacks, they are not interchangeable. Therefore, these different wireless networks will continue to co-exist in the future. Moreover, since these wireless networks have their respective signal coverage ranges, these ranges may or may not overlap. In order that a user can utilize different wireless networks as he/she wishes, integrating different wireless networks to enable the user to roam among them has become a current trend.

Referring to FIG. 1, in a conventional architecture integrating two wireless networks, a plurality of first wireless access nodes 11, a plurality of second wireless access nodes 12, and a core network 14 are connected through an Internet Protocol (IP) backbone network 13 in a wired manner for transmission of data. The first wireless access nodes 11 form a first wireless network. The second wireless access nodes 12 form a second wireless network. Data transmission between a mobile node 15 and one of the wireless access nodes 11, 12 is in a wireless manner.

In order to protect the security of transmitted data, wireless networks have developed their own security mechanisms (including authentication and encryption), which address their respective characteristics, and which are realized in their respective wireless access nodes. Once the design of the wireless access nodes 11, 12 is completed, the security mechanism supported thereby is also fixed and cannot be altered. If a new security mechanism is developed for the first or second wireless network, new first or second wireless access nodes 11, 12 have to be designed, with the original first or second wireless access nodes 11, 12 phased out, so as to enable the first or second wireless network to use the new security mechanism.

Furthermore, if the integrated wireless network as shown in FIG. 1 needs to integrate a newly developed third wireless network thereinto, aside from designing and arranging a plurality of third wireless access nodes to construct the third wireless network, in order that the mobile node 15 can roam among the three wireless networks, the security mechanisms supported by the first wireless access nodes 11, the second wireless access nodes 12, and the third wireless access nodes must be compatible. This gives rise to a need to design new first and second wireless access nodes 11, 12, with the original first and second wireless access nodes 11, 12 phased out.

Therefore, much time and cost need to be invested when updating the security mechanism supported by the wireless access nodes in the conventional integrated wireless network.

### SUMMARY OF THE INVENTION

Therefore, an object of the present invention is to provide a security reconfigurable device, which can reduce time and cost for updating a security mechanism.

Another object of the present invention is to provide a method for security reconfiguration, which can reduce time and cost for updating a security mechanism.

Accordingly, the security reconfigurable device of the present invention is adapted for use in an integrated wireless network integrating at least two wireless networks, and includes a plurality of security modules and a control unit. The security modules are adapted to respectively realize security mechanisms relating to the wireless networks. According to security requirements, the control unit selects one of the security modules for operation.

The method for security reconfiguration of the present invention is adapted for use in an integrated wireless network integrating at least two wireless networks, and includes the following steps: providing a plurality of security modules, the security modules respectively realizing security mechanisms related to the wireless networks; and according to security requirements, selecting one of the security modules for operation.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional integrated wireless network;

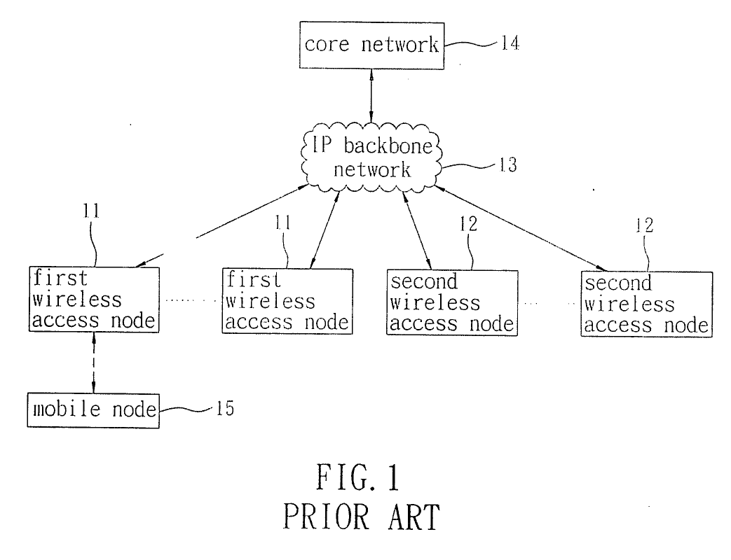

FIG. 2 is a schematic diagram to illustrate an integrated wireless network to which the present invention can be applied;

FIG. 3 is a block diagram to illustrate the preferred embodiment of a security reconfigurable device according to the present invention;

FIG. 4 is a schematic diagram to illustrate an IP stack;

FIG. 5 is a block diagram to illustrate another preferred embodiment of a security reconfigurable device according to the present invention; and

FIG. 6 is a flowchart to illustrate the preferred embodiment of a method for security reconfiguration according to the present invention.

### DETAILED DESCRIPTION OF THE PREFERRED EMBODIMENTS

Before the present invention is described in greater detail, it should be noted that like elements are denoted by the same reference numerals throughout the disclosure.

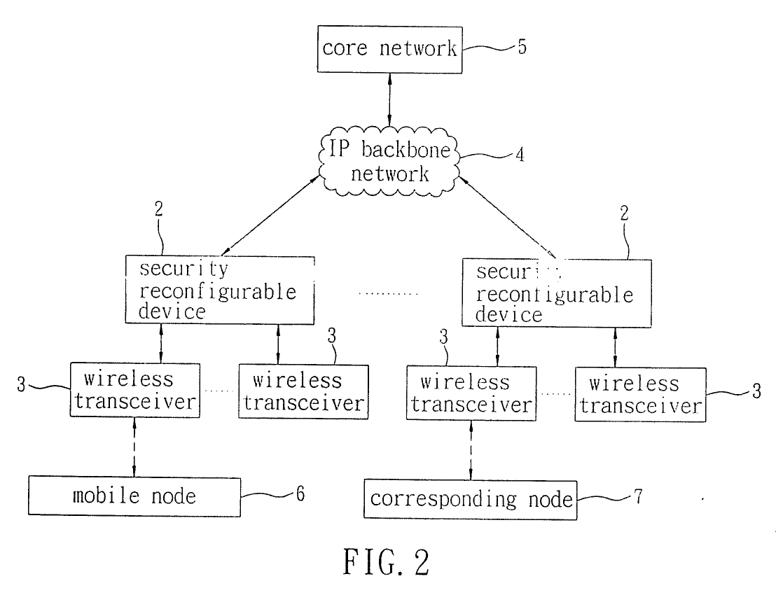

Referring to FIG. 2, the preferred embodiment of a security reconfigurable device 2 according to the present invention is adapted for use in an integrated wireless network integrating at least two wireless networks. In the architecture of the integrated wireless network, a plurality of security reconfigurable devices 2 and a core network 5 are connected through an IP backbone network 4 in a wired manner for transmission of data. Data transmission between each of the security reconfigurable devices 2 and a plurality of wireless transceivers 3 is in a wired manner. The wireless transceivers 3 form the wireless networks. Data transmission between a mobile node 6 and one of the wireless transceivers 3 is in a wireless manner.

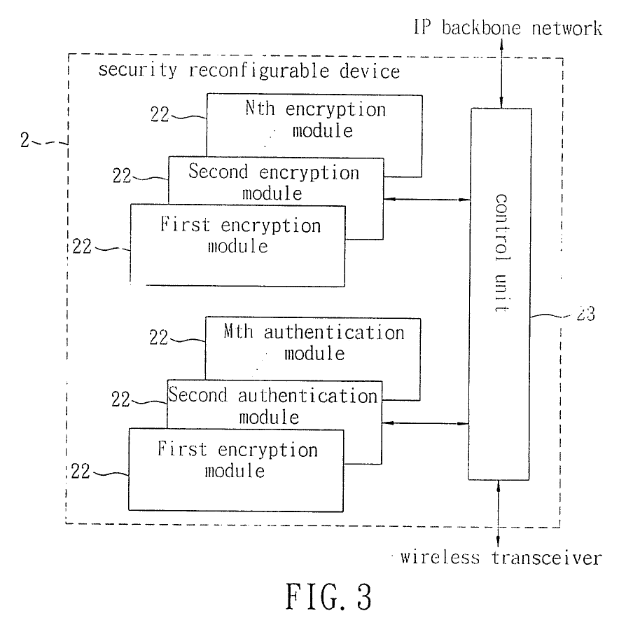

Referring to FIG. 3, the preferred embodiment of the security reconfigurable device 2 according to the present invention includes a plurality of authentication modules 21, a plurality of encryption modules 22, and a control unit 23. The authentication modules 21 respectively realize authentication mechanisms related to the wireless networks. Each of the authentication modules 21 includes certificates and authentication algorithms. The encryption modules 22 respectively realize encryption mechanisms related to the wireless networks. Each of the encryption modules 22 includes keys and an encryption algorithm. According to security requirements, the control unit 23 selects one of the authentication modules 21 to perform authentication, and selects one of the encryption modules 22 to perform encryption.

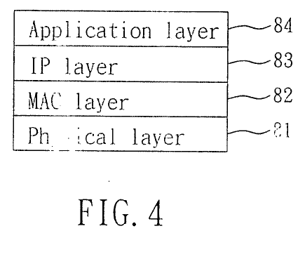

Referring to FIG. 4, an IP stack includes a physical layer 81, a media access control (MAC) layer 82, an IP layer 83, and an application layer 84. The preferred embodiment can be applied to at least one of the MAC layer 82, the IP layer 83, and the application layer 84.

Referring to FIGS. 2 and 3, when the preferred embodiment is applied to the MAC layer 82, the control unit 23 sets the wireless transceiver 3 corresponding to the mobile node 6 so that the selected authentication module 21 can execute authentication between the wireless transceiver 3 and the mobile node 6, and so that the selected encryption module 22 can encrypt data transmitted to the mobile node 6 from the wireless transceiver 3. In this way, snooping problems that may be encountered during data transmission between the wireless transceiver 3 and the mobile node 6 can be overcome. For example, in a situation where WLAN is used, since there is a likely sham wireless transceiver, if the required security of the service used is of a relatively high level, mutual authentication can be selectively employed. But if the required security of the service used is of a relatively low level and there cannot be a relatively long delay, a simpler authentication process can be selectively employed.

When the preferred embodiment is applied to the IP layer 83 and/or the application layer 84, the selected authentication module 21 of one of the security reconfigurable devices 2 executes authentication between said one of the security reconfigurable devices 2 and another one of the security reconfigurable devices 2, and the selected encryption module 22 of said one of the security reconfigurable devices 2 encrypts data transmitted from said one of the security reconfigurable devices 2 to said another one of the security reconfigurable devices 2. In this way, when data is transmitted between a mobile node 6 and a corresponding node 7 through two security reconfigurable devices 2, snooping problems that may be encountered during transmission between the two security reconfigurable devices 2 can be overcome.

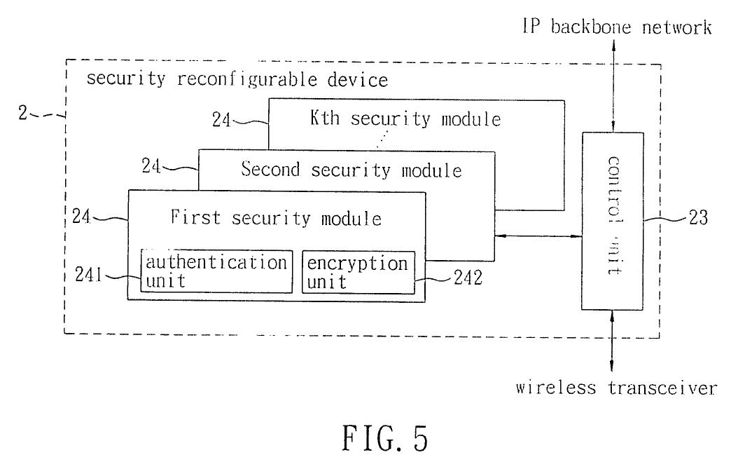

It is noted that, in this embodiment, each security reconfigurable device 2 includes authentication and encryption modules 21, 22. However, in another embodiment of the present invention, the security reconfigurable device 2 may include only one of the authentication and encryption modules 21, 22. Referring to FIG. 5, in still another embodiment of the present invention, the security reconfigurable device 2 may include a plurality of security modules 24, each of which includes an authentication unit 241 for realizing an authentication mechanism, and an encryption unit 242 for realizing an encryption mechanism. In this case, the control unit 23 selects one of the security modules 24 to perform authentication and encryption according to security requirements.

Since the integrated wireless network of the present invention includes many different security mechanisms, and since new security mechanisms may be developed, by modularizing different security mechanisms, the preferred embodiments allow for selection of different security modules to address different security requirements, and allow for addition of new security mechanisms. Thus, the present invention has advantages of flexibility, reconfigurability, and expandability.

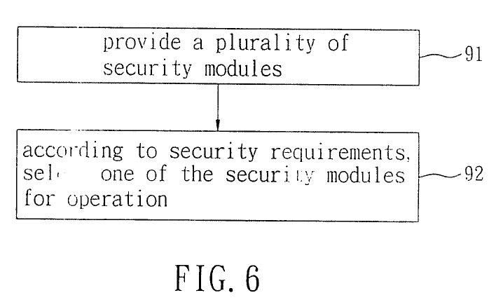

Referring to FIG. 6, the method for security reconfiguration employed in the present invention includes the following steps:

In step 91, a plurality of security modules are provided.

In step 92, according to security requirements, one of the security modules is selected for operation.

The method may further include a step of adding a new security module such that, when a new security mechanism is developed, the new security mechanism can be used.

In sum, by using a portion of the conventional wireless access nodes which is responsible for wireless transmission to construct a wireless transceiver 3, and by integrating a portion of the conventional wireless access nodes which is responsible for security mechanisms with a portion of other conventional wireless access nodes which is responsible for security mechanisms, the security reconfigurable device 2 can be constructed. Thus, the present invention permits selection of different security modules to address different security requirements, and addition of new security modules, thereby reducing the time and cost needed to update the security mechanisms.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A security reconfigurable device adapted for use in an integrated wireless network integrating at least two wireless networks, said security reconfigurable device comprising:
a plurality of security modules adapted to respectively realize security mechanisms related to the wireless networks; and
a control unit for selecting, according to security requirements, one of said security modules for operation.

2. The security reconfigurable device according to claim 1, wherein said security modules are used for authentication.

3. The security reconfigurable device according to claim 1, wherein said security modules are used for encryption.

4. The security reconfigurable device according to claim 1, wherein said security modules are used for authentication and encryption.

5. The security reconfigurable device according to claim 1, wherein said security reconfigurable device is adapted for application to a media access control layer.

6. The security reconfigurable device according to claim 1, wherein said security reconfigurable device is adapted for application to an Internet Protocol layer.

7. The security reconfigurable device according to claim 1, wherein said security reconfigurable device is adapted for application to an application layer.

8. A method for security reconfiguration adapted for use in an integrated wireless network integrating at least two wireless networks, comprising the following steps:
providing a plurality of security modules, the security modules respectively realizing security mechanisms related to the wireless networks; and
according to security requirements, selecting one of the security modules for operation.

9. The method for security reconfiguration according to claim 8, wherein the security modules are used for one of authentication and encryption.

10. The method for security reconfiguration according to claim 8, wherein the security modules are used for authentication and encryption.

11. The method for security reconfiguration according to claim 8, wherein the method is adapted for application to at least one of a media access control layer, an Internet Protocol layer, and an application layer.

12. The method for security reconfiguration according to claim 11, wherein the security modules are used for one of authentication and encryption.

13. The method for security reconfiguration according to claim 11, wherein the security modules are used for authentication and encryption.

14. The method for security reconfiguration according to claim 8, further comprising a step of adding a new security module.

15. The method for security reconfiguration according to claim 14, wherein the method is adapted for application to at least one of a media access control layer, an Internet Protocol layer, and an application layer.

16. The method for security reconfiguration according to claim 15, wherein the security modules are used for one of authentication and encryption.

17. The method for security reconfiguration according to claim 15, wherein the security modules are used for authentication and encryption.
